(19) United States
(12) Patent Application Publication
(10) Pub. No.: US 2012/0319444 A1
(43) Pub. Date: Dec. 20, 2012

(54) Sitting and Standing Chair

(76) Inventor: Paul Onopa, Vulcan, MI (US)

(21) Appl. No.: 13/523,726

(22) Filed: Jun. 14, 2012

Related U.S. Application Data
(60) Provisional application No. 61/496,661, filed on Jun. 14, 2011.

(51) Int. Cl. A47C 3/30; A47C 7/50; A47C 7/00; A47C 3/20; A47C 3/00; B60B 33/00

(52) U.S. Cl. 297/338; 297/354.12

(57) ABSTRACT

A sitting and standing chair includes a plurality of caster wheels, a floor plate, a seat rest, a back rest, and a leg rest all secured to a support member. The floor plate is attached to one side of the support member with a hinge to be folded downward to rest on the ground when the chair is used for standing. The floor plate is folded upward when the chair is used for sitting for being moved. The back rest is similarly attached to the support member so that it faces the seat rest when the chair is used for sitting and pivoted away from the seat rest when the chair is used for standing. The floor plate prevents the chair from moving while an individual leans against the leg rest and/or back rest while standing.

### CROSS-REFERENCE TO RELATED APPLICATIONS

This application claims priority to U.S. Provisional Application No. 61/496,661, filed on Jun. 14, 2011, which is hereby incorporated by reference in its entirety.

### FIELD OF INVENTION

The present invention relates to the field of chairs and more particularly to a combination sitting and standing chair.

### BRIEF DESCRIPTION OF THE DRAWINGS

FIG. 1 illustrates a perspective view of an exemplary embodiment of a sitting and standing chair with the floor plate extended.

FIG. 2 illustrates a perspective view of an exemplary embodiment of a sitting and standing chair with the floor plate folded.

FIG. 3 illustrates a side view of an exemplary embodiment of a sitting and standing chair with the floor plate extended.

FIG. 4 illustrates a side view of an exemplary embodiment of a sitting and standing chair with the floor plate folded.

FIG. 5 illustrates a side view of an exemplary embodiment of a sitting and standing chair with the back rest reversed.

### GLOSSARY

As used herein, the term “clover-like bend” refers to an inward contour formed on an otherwise substantially straight component which creates two lobes.

As used herein, the term “squared” means having a substantially square shape including two sets of generally parallel sides.

### BACKGROUND

Recent studies have found that individuals who sit for most of the day are 54 percent more likely to die of heart attacks. In addition, sitting for long periods of time may affect an individual's posture and cause lower back pain. These studies also found that individuals who stand burn 60 more calories per hour than individuals who sit. These studies have lead to the increasingly popularity of standup desks.

Apparatuses which support an individual in a standing position are known in the art. One such example is disclosed in U.S. Patent Publication No. 2002/0171283 (Liebeskind '283). Liebeskind '283 teaches an apparatus comprised of a base, a support column, and an elongated body support member for the individual to rest his or her body against. The elongated body support member further includes a lumbar support member and arms on either side of the elongated body support member. The base is generally rectangular with a large width at the front, tapering to a narrower width at the rear. Foot supports are attached to the bottom surface of the base at the front portion of the base. The standing support apparatus taught by Liebeskind '283 is not desirable because the large elongated body support member and the design of the base make the apparatus cumbersome to move.

### SUMMARY OF THE INVENTION

The present invention is a sitting and standing chair comprised of a support member, a plurality of caster wheels secured to the bottom of the support member, a floor plate secured to one side of the support member, a seat rest secured to the top of the support member, a back rest, and a leg rest. The floor plate is attached to one side of the support member and is hinged. The floor plate is folded downward and rests on the ground when the chair is used for standing. The floor plate is folded upward when the chair is used for sitting for being moved. The back rest is positioned so that it faces the seat rest when the chair is used for sitting and away from the seat rest when the chair is used for standing. The plurality of wheels allow the chair to be easily maneuvered and moved between locations, while the floor plate prevents the chair from moving while an individual leans against the leg member and/or back rest.

### DETAILED DESCRIPTION OF INVENTION

For the purpose of promoting an understanding of the present invention, references are made in the text to exemplary embodiments of a sitting and standing chair, only some of which are described herein. It should be understood that no limitations on the scope of the invention are intended by describing these exemplary embodiments. One of ordinary skill in the art will readily appreciate that alternate but functionally equivalent materials, components, and designs may be used. The inclusion of additional elements may be deemed readily apparent and obvious to one of ordinary skill in the art. Specific elements disclosed herein are not to be interpreted as limiting, but rather as a basis for the claims and as a representative basis for teaching one of ordinary skill in the art to employ the present invention.

It should be understood that the drawings are not necessarily to scale; instead, emphasis has been placed upon illustrating the principles of the invention. In addition, in the embodiments depicted herein, like reference numerals in the various drawings refer to identical or near identical structural elements.

Moreover, the terms “substantially” or “approximately” as used herein may be applied to modify any quantitative representation that could permissibly vary without resulting in a change in the basic function to which it is related.

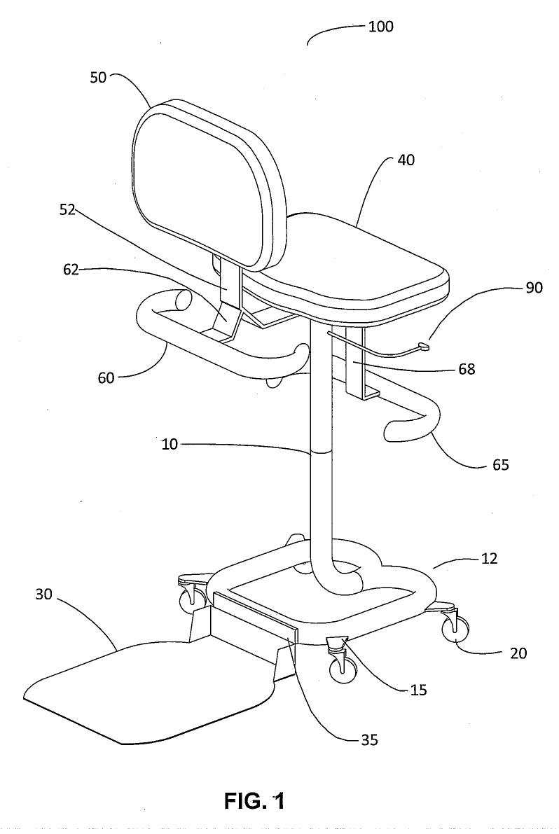

FIG. 1 illustrates a perspective view of an exemplary embodiment of sitting and standing chair 100. In the embodiment shown, sitting and standing chair 100 is comprised of support member 10, a plurality of caster wheels 20 secured to the bottom of support member 10, floor plate 30 secured to one side of support member 10, seat rest 40 secured to the top of support member 10, back rest 50, leg rest 60 and foot rest 65.

In the embodiment shown, support member 10 is comprised of a bent steel tube having a diameter of 2 inches. In various other embodiments, support member 10 has a smaller or larger diameter, may be comprised of another material, and/or may be of a different design.

As illustrated, support member 10 is bent to create lower stability portion 12 with a plurality of caster-spreading projections 15 to which caster wheels 20 are attached. In the exemplary embodiment shown, lower stability portion 12 is squared with curved transitions and a single clover-like bend, or a bend creating an inward curve and resulting in two lobed portions, on one side of squared lower stability portion 12.

Lower stability portion 12 with caster-spreading projections 15 creates a wheel base of approximately 35 inches by 35 inches as measured using the diagonals of squared lower stability portion 12. Each side of lower stability portion 12 is approximately 24 inches. In further exemplary embodiments, lower stability portion 12 may vary in size proportionally with the size of floor plate 30 or the anticipated weight and size of a user. For example, the sides of lower stability portion 12 may vary in the range of 18-30 inches. In still further exemplary embodiments, lower stability portion 12 may not be squared and include sides having different lengths.

The clover-like bend increases the stability of sitting and standing chair 100 when in use. In other exemplary embodiments, lower stability portion 12 may include more or fewer clover-like bends. In still other exemplary embodiments, caster-spreading projections 15 may be positioned differently around lower stability portion 12.

Caster wheels 20 are attached to the bottom of support member 10 using caster-spreading projections 15 and allow sitting and standing chair 100 to be easily moved and maneuvered. In the embodiment shown, sitting and standing chair 100 includes four swivel caster wheels 20, each attached to lower stability portion 12 by a caster-spreading projection 15; however, in other embodiments the number of caster wheels 20 and caster-spreading projections 12 may vary.

In some exemplary embodiments, the size, configuration and material of caster wheels 20 may vary based on the weight of an anticipated user.

Floor plate 30 is attached to one side of lower stability portion 12 using hinge 35, allowing floor plate 30 to be pivoted between an extended and folded position. When floor plate 30 is in the extended position as shown in FIG. 1, floor plate 30 rests on the ground and prevents sitting and standing chair 100 from moving even when an individual is resting against leg rest 60 and back rest 50.

In an exemplary embodiment, floor plate 30 is approximately square, being approximately 19 to 21 inches wide and approximately 20 to 27 inches long.

The dimensions of floor plate 30 are critical because the size of floor plate 30 contributes to the stability of sitting and standing chair 100 when floor plate 30 is extended. A smaller floor plate 30 creates instability because a user's weight, when standing, is providing more force on the upper components of sitting and standing chair 100, such as back rest 50 and leg rest 60.

A longer floor plate 30 is not able to fit under leg rest 60 when folded. Larger floor plates 30 are also impractical because users may trip over or slip on the extra material when floor plate 30 is extended and bump into floor plate 30, causing injury, when floor plate 30 is folded.

In further exemplary embodiments, floor plate 30 may be a different shape which is able to conform to the necessary critical dimensions, including oval-shaped and stingray-shaped. In the exemplary embodiment shown, floor plate 30 is comprised of an aluminum diamond plate; however, in other embodiments floor plate 30 may be comprised of another type of material. In various embodiments, a gel mat or another type of cushion may be placed on the top of floor plate 30. In still further exemplary embodiments, floor plate 30 may include additional coatings or surface textures, such as no-slip material, treads, and waterproofing or easy-clean coatings.

In yet further exemplary embodiments, when floor plate 30 is made from aluminum diamond plate or other reflective or shiny material, floor plate 30 may include a non-reflective coating.

In still further exemplary embodiments, floor plate 30 may include contours, such as an upward lip at the unattached end of floor plate 30. An upward lip at the unattached end of floor plate 30 allows floor plate 30 to remain extended as sitting and standing chair 100 is rolled across a textured or carpeted floor without snagging or getting caught. An upward lip also alerts users that they are standing near the edge of floor plate 30 and may be disposed around the entire perimeter of floor plate 30 as a safety feature.

Seat rest 40 is secured to the top of support member 10. In the embodiment shown, the height of seat rest 40 is adjustable using an office chair lever and gas spring known in the art. The mechanisms for adjusting seat rest 40 are secured under seat rest 40 and positioned so that a user in sitting or standing position may easily adjust the height of seat rest 40. Visible in the exemplary embodiment shown in FIG. 1 is adjustment lever 90. In further exemplary embodiments, the mechanisms for adjusting seat rest 40 may be located anywhere on sitting and standing chair 100.

In other exemplary embodiments, any mechanism known in the art may be used to adjust the height of seat rest 40. In various other embodiments, sitting and standing chair 100 further includes arm rests providing a place for an individual to rest his or her arms while sitting on seat rest 40. The arm rests may also be capable of being swiveled around for use while standing.

In the exemplary embodiment shown, seat rest 40 is adjustable up to approximately 38 inches in height to correspond to the average height of “counter height” furniture. In most exemplary embodiments, seat rest 40 is not adjustable below 30 inches. Because sitting and standing chair 100 is used with standing-height or counter height furniture, it is unlikely seat rest 40 will need to be adjusted below 30 inches; however, in some exemplary embodiments, seat rest 40 may be adjustable below 30 inches.

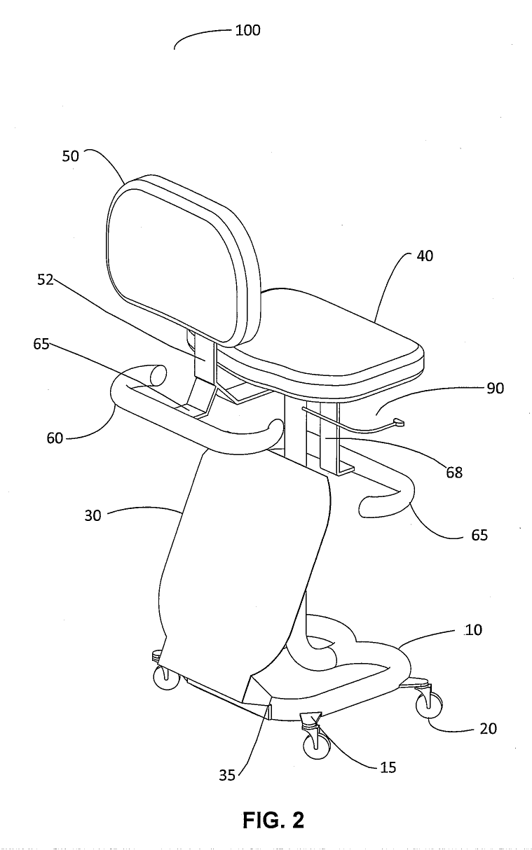

In the embodiment shown, back rest 50 is in the standing position, i.e., turned away from seat rest 40, and supported by back brace 52. Back rest 50 is pivotally attached to back brace 52 and may be pivoted toward seat rest 40 when sitting and standing chair 100 is used for sitting (see FIG. 2). Back brace 52 is generally L-shaped and holds back rest 50 upward from seat rest 40.

In the embodiment shown, seat rest 40 and back rest 50 are comprised of a solid, hard material, such as wood, as a base with a padded cover. In further exemplary embodiments, seat rest 40 and back rest 50 may be comprised of any material known in the art to provide a strong, structural support for sitting and leaning and may or may not include padding. In still further exemplary embodiments, seat rest 40 and back rest 50 may contain aesthetic designs, such as company names/logos, team names/logos and other indicia.

Leg rest 60 supports the individual's legs or buttocks while standing, while foot rest 65 supports an individual's feet while sitting. As illustrated, both leg rest 60 and foot rest 65 are tubular members having a primarily straight body with the ends curved inward toward support member 10. In further exemplary embodiments, leg rest 60 and foot rest 65 may have a different shape.

In the exemplary embodiment shown, leg rest 60 connects to seat rest 40 through leg rest brace 62, which joins with back brace 52. Foot rest 65 is secured below seat rest 40 by foot rest brace 68, which extends downward from seat rest 40. In other exemplary embodiments, however, leg rest 60 and foot rest 65 may secure directly to support member 10 or any other structure of sitting and standing chair 100 through any means known in the art.

Leg rest brace 62 is generally V-shaped, with one end of the V securing to leg rest 60 and the other joining back brace 52 while foot rest brace 68 is approximately L-shaped to hold foot rest 65 downward from seat rest 40. In further exemplary embodiments, leg rest brace 62 and foot rest brace 68 may be any shape known in the art to secure leg rest 60 and foot rest 65, respectively, in an appropriate and comfortable position for a user. In some exemplary embodiments, the position, angle and exact orientation of leg rest 60 and foot rest 65 may be adjustable by a user.

In the exemplary embodiment shown, leg rest 60 and foot rest 65 are made of the same material as support member 10. In still further exemplary embodiments, leg rest 60 may include a covering or coating which provides cushioning or padding to increase comfort while using sitting and standing chair 100 in the standing position.

Similarly, foot rest 65 may include a covering, coating or surface texture, such as a friction-increasing texture or non-slip coating, to prevent a user's feet from sliding on foot rest 65. In still further exemplary embodiments, additional coverings, coatings or surface textures may be applied to foot-rest 65 to increase an individual's comfort, such as padding, ergonomic contours, and these and combinations of other coverings, coatings or surface textures known in the art.

FIG. 2 illustrates a perspective view of an exemplary embodiment of sitting and standing chair 100 with floor plate 30 folded. As illustrated, floor plate 30 pivots at hinge 35 and folded floor plate 30 does extend beyond leg rest 60.

In the exemplary embodiment shown, hinge 35 is a case hinge. In further exemplary embodiments, floor plate 30 may be pivotally connected to support member 10 using any hinge-type connection known in the art or through any other means known in the art to provide a pivotal connection, including, but not limited to, barrel hinges, pivot hinges, butt/mortise hinges, piano hinges, flag hinges, and combinations of these and other structures.

In further exemplary embodiments, floor plate 30 may be configured to slide underneath lower stability portion 12 for storage when sitting and standing chair 100 is being used for sitting. For example, floor plate 30 may be configured with a slide rail system which allows floor plate 30 to be slid under lower stability portion 12 and secured a distance up from the floor. Lower stability portion may also contain pivoting components which allow floor plate 30 to rotate upwards and inwards relative to lower stability portion 12 for storage. Lower stability portion 12 may also include a protective aperture into which floor plate 30 is slid for storage and transport to prevent damage to floor plate 30 when not in use.

In still further exemplary embodiments, floor plate 30 may have a lower surface designed to be in continual contact with the floor. For example, the lower surface of floor plate 30 may include a low-friction coating, wheels or casters, ski-type structures or any other structure or combination of structures known in the art to allow floor plate 30 to slide primarily unhindered along a surface.

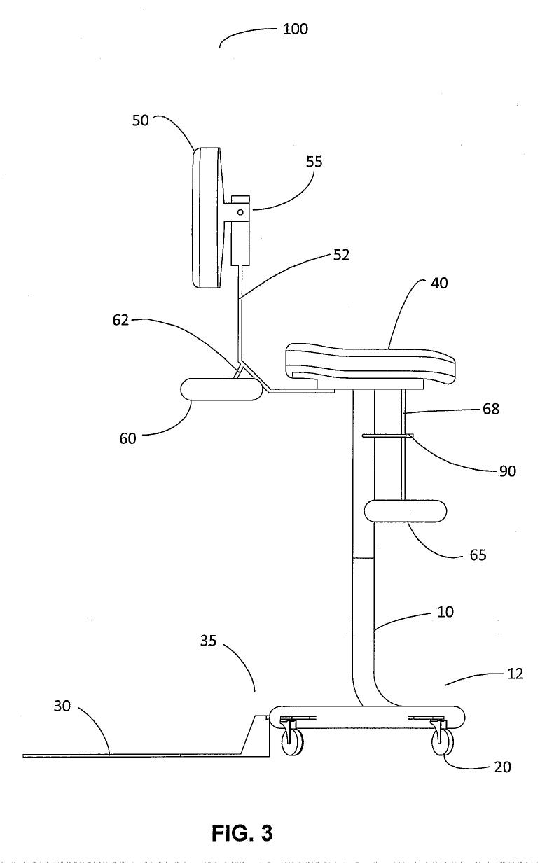

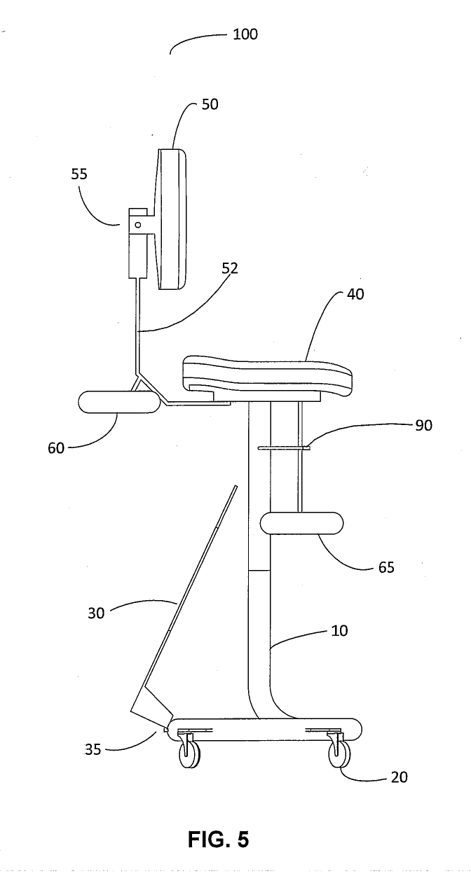

FIG. 3 illustrates a side view of an exemplary embodiment of sitting and standing chair 100 with floor plate 30 extended. Seen in FIG. 3 is hinge 55 for back rest 50. In the exemplary embodiment shown, back rest 50 is positioned over leg rest 60 to support an individual in the standing position. As illustrated in FIG. 5, back rest 50 may be flipped using hinge 55 to be in a position above seat rest 40 to support an individual in a seated position.

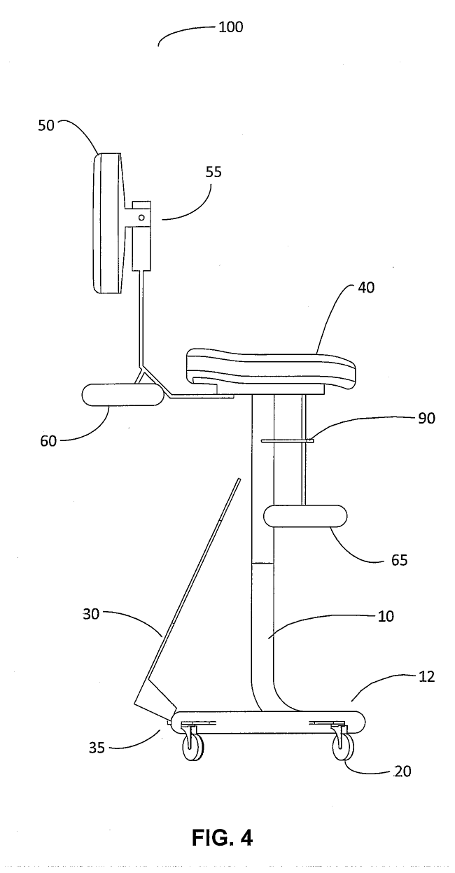

FIG. 4 illustrates a side view of an exemplary embodiment of sitting and standing chair 100 with floor plate 30 folded.

As illustrated, back rest 50 is angled at an approximate 10 to 20 degree pitch as measured from a line extending vertically from support member 10, with the bottom of back rest 50 tilted away from support member 10, for the comfort of a user. When flipped to its seated position, back rest 50 will also be angled at an approximate 10 to 20 degree pitch, mirroring its standing position angle. In some exemplary embodiments, back rest 50 will be angled at approximately 105 degrees as measured from seat rest 40 when back rest 50 is in its seated position, or 15 degrees as measured from a line extending vertically from support member 10.

In further exemplary embodiments, back rest 50 may not be angled. In still further exemplary embodiments, the pitch of back rest 50 may be manually adjustable by a user.

FIG. 5 illustrates a side view of an exemplary embodiment of sitting and standing chair 100 with back rest 50 reversed to the sitting position. Back rest 50 is now positioned over seat rest 40.

In the exemplary embodiment shown, back rest 50 is connected to back brace 52, which joins back rest 50 to seat rest 40. Back brace 52 includes hinge 55, which in the exemplary embodiment shown is a pivot hinge. However, in further exemplary embodiments, hinge 55 may be any structure or combination of structures known in the art to provide a pivotal connection and allow back rest 50 to flip between its standing and seated position, including, but not limited to, case hinges, barrel hinges, butt/mortise hinges, piano hinges, flag hinges, and combinations of these and other structures.

What is claimed is:

1. A sitting and standing support apparatus comprised of:
a vertical support member having a top end and a bottom end, wherein said bottom end includes horizontal squared lower stability portion;
a plurality of caster wheels attached to said horizontal squared lower stability portion;
a floor plate pivotally attached to one side of said horizontal squared lower stability portion and pivotal between two selectable positions;
a seat rest secured to said top end of said vertical support member; and
a back rest pivotally connected to said seat rest and pivotal between a seated position and a standing position.

2. The apparatus of claim 1 wherein said vertical support member is comprised of bent steel tube having a diameter of 2 inches.

3. The apparatus of claim 1 wherein said horizontal squared lower stability portion includes at least one clover-like bend.

4. The apparatus of claim 1 wherein said horizontal square lower stability portion further includes a plurality of caster-spreading projections which secure said plurality of caster wheels.

5. The apparatus of claim 4 wherein there are 4 caster wheels and 4 caster-spreading projections.

6. The apparatus of claim 1 wherein said seat rest and said back rest are padded.

7. The apparatus of claim 1 wherein said floor plate is square.

8. The apparatus of claim 1 wherein said floor plate has a width between 19 and 21 inches and a length between 20 and 27 inches.

9. The apparatus of claim 1 wherein said floor plate is comprised of aluminum diamond plate.

10. The apparatus of claim 9 wherein said floor plate further includes a non-reflective coating.

11. The apparatus of claim 1 wherein said seat rest has an adjustable height.

12. The apparatus of claim 11 wherein the height of said seat rest is adjustable between 30 and 38 inches.

13. The apparatus of claim 1 which further includes a chair lever and gas spring seat rest height adjustment mechanism.

14. The apparatus of claim 1 wherein said back rest is connected to said seat rest by a back brace.

15. The apparatus of claim 1 wherein said back rest is angled at an angle between 10 and 20 degrees in at least one of said seated position and said standing position.

16. The apparatus of claim 1 which further includes a leg rest connected to said seat rest and positioned above said floor plate.

17. The apparatus of claim 1 which further includes a foot rest connected to said seat rest and positioned below said seat rest opposite said leg rest.

18. An adjustable chair and support apparatus comprised of:
a vertical support member having a top end and a bottom end, wherein said bottom end includes horizontal squared lower stability portion;
wherein said horizontal squared lower stability portion includes a plurality of caster-spreading projections and at least one clover-like bend;
a plurality of caster wheels, wherein each one of said plurality of caster wheels is secured to one of said plurality of caster-spreading projections;
a floor plate pivotally attached to one side of said horizontal squared lower stability portion and pivotal between an extended position and a folded position;
a seat rest with an adjustable height secured to said top end of said vertical support member;
a back rest pivotally connected to said seat rest by a back brace and pivotal between a seated position and a standing position;
a leg rest connected to said seat rest above said floor plate; and
a foot rest connected to and projecting below said seat rest opposite said leg rest.

19. The apparatus of claim 18 wherein said floor plate is pivotally connected to said horizontal squared lower stability portion using a structure selected from the group consisting of a pivot hinge, a case hinge, a barrel hinge, a butt/mortise hinge, a piano hinge, a flag hinge and combinations thereof.

20. The apparatus of claim 18 wherein said back rest is pivotally connected to said back brace using a structure selected from the group consisting of a pivot hinge, a case hinge, a barrel hinge, a butt/mortise hinge, a piano hinge, a flag hinge and combinations thereof.
